(19) United States
(12) Patent Application Publication
(10) Pub. No.: US 2024/0198317 A1
(43) Pub. Date: Jun. 20, 2024

(54) DISPERSED CARBONATE CATALYSTS FOR THE REVERSE WATER-GAS SHIFT REACTION

(71) Applicant: The Board of Trustees of the Leland Stanford Junior University, Stanford, CA (US)

(72) Inventors: Matthew W. KANAN, Palo Alto, CA (US); Amy Delano FRANKHOUSER, Oakland, CA (US); Chastity S. LEE, Palo Alto, CA (US)

(21) Appl. No.: 18/555,826

(22) PCT Filed: Apr. 19, 2022
(86) PCT No.: PCT/US2022/025361

§ 371 Date: Oct. 17, 2023

Related U.S. Application Data
(60) Provisional application No. 63/177,091, filed on Apr. 20, 2021.

(51) Int. Cl. B01J 23/04; B01J 35/80; C01B 32/40; C10K 3/02

(52) U.S. Cl. CPC B01J 23/04; B01J 35/80; C01B 32/40; C10K 3/026

(57) ABSTRACT

A catalyst for performing the reverse-water-gas-shift (RWGS) reaction is provided comprising an alkali carbonate dispersed on a porous support.

### CROSS REFERENCE TO RELATED APPLICATIONS

This application claims priority under 35 U.S.C. § 119 from U.S. Application No. 63/177,091, filed Apr. 20, 2021, entitled CARBONATE-CATALYZED REVERSE WATER GAS SHIFT TO PRODUCE GAS FERMENTATION FEEDSTOCKS FOR RENEWABLE LIQUID FUELS, by Kanan et al., which is incorporated herein by reference for all purposes.

### GOVERNMENT RIGHTS

This invention was made with Government support under contract U.S. Department of Energy (DE-SC0020394) and NASA Grant Number 80NSSC2K0181. The Government has certain rights in the invention.

### BACKGROUND

The background description provided here is for the purpose of generally presenting the context of the disclosure. Information described in this background section, as well as aspects of the description that may not otherwise qualify as prior art at the time of filing, are neither expressly nor impliedly admitted as prior art against the present disclosure.

This invention relates to converting CO₂ into renewable fuels and chemicals using H₂ gas. Specifically, the invention relates to CO₂ to CO conversion by the reverse water gas shift reaction, which can be coupled with downstream processes to generate liquid fuels or chemicals. Conventional renewable fuel and chemical production using biomass has various limitations including low efficiency for natural photosynthesis, large land requirements, and competition with food generation.

### SUMMARY

To achieve the foregoing and in accordance with the purpose of the present disclosure, a catalyst for performing the reverse-water-gas-shift (RWGS) reaction is provided comprising an alkali carbonate dispersed on a porous support.

In another manifestation, a method is provided comprising, providing an alkali carbonate catalyst on a porous support, supplying the catalyst with a flow of CO₂ and H₂ gas, and heating the catalyst to ≥350° C., resulting in an output containing CO.

These and other features of the present invention will be described in more detail below in the detailed description of the disclosure and in conjunction with the following figures.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1 is a high level flow chart of a method used in some embodiments.

FIG. 2A is a schematic illustration of a carbonate-catalyzed reverse water gas shift cycle.

FIG. 2B is a schematic illustration of a reversible deprotonation of H₂S.

FIG. 3 is a graph showing equilibrium-limited CO₂ conversion percentage to CO versus temperature.

FIG. 4A shows SEMs of the dispersed carbonate catalysts on a porous substrate.

FIG. 4B is a graph of absorbance versus wave number.

FIG. 5A is a graph that compares the steady-state CO yield at each temperature step for dispersed carbonates, unloaded oxide supports, and a commercial Pt catalyst.

FIG. 5B is a graph that compares the CO₂ conversion and selectivity for CO vs temperature for Pt/TiO₂, Cs₂CO₃/TiO₂, and Cs₂CO₃/Al₂O₃.

FIG. 6A are graphs of CO and CH₄ yield versus time.

FIG. 6B are graphs illustrating the stability of the catalysts at sub-equilibrium conversion.

FIG. 6C are graphs illustrating the effect of sulfur-containing impurities.

FIG. 7 is a graph illustrating the RWGS performance for CO yield at different temperatures for K₂CO₃.

FIG. 8 is a graph illustrating the RWGS performance for CO yield at different temperatures for Cs₂CO₃.

FIG. 9 is a schematic view of a system for providing RWGS used in some embodiments.

### DETAILED DESCRIPTION OF ILLUSTRATED EMBODIMENTS

This invention relates to the reaction of CO₂ and H₂ to form CO and H₂O, which is known as the reverse water gas shift reaction (RWGS, as shown in Eq. 1).

$$C {O}_{2} + {H}_{2} \to C O + {H}_{2} O ( {ΔH°}_{298 K} = 42.1 kj {mol}^{- 1} ) \qquad Equation 1$$

RWGS is typically performed by flowing a gas mixture containing CO₂ and H₂ over a catalyst in a reactor and heating the reactor to maintain a desired reaction temperature. Because RWGS is endothermic, the equilibrium-limited single-pass conversion to the products CO and H₂O increases as the reaction temperature is increased.

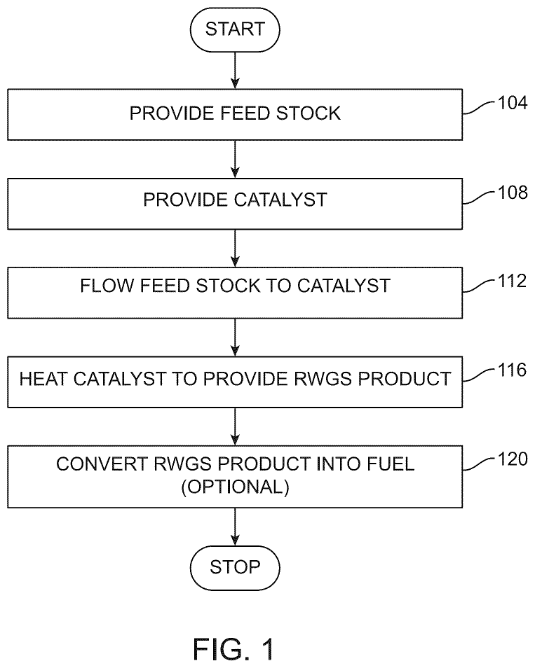

In some embodiments, RWGS using the catalysts disclosed in this invention can be used as part of a process that produces liquid fuels or multi-carbon chemicals (chemicals whose molecular formula contains more than 1 carbon). In order to facilitate understanding, FIG. 1 is a high level flow chart of a method used in some embodiments. A feedstock for RWGS containing CO₂ and H₂ is provided (step 104). A RWGS catalyst disclosed in this invention is provided (step 108). The feedstock is flowed to the RWGS catalyst in a reactor (step 112) and heat is supplied to the reactor to convert the feedstock gas into the RWGS product gas (step 116). In some embodiments, the RWGS product gas is further converted into a liquid fuel or other chemical product using a chemical or biological process (step 120).

In some embodiments, providing the feedstock (step 104) comprises providing water electrolysis to produce the H₂ of the feedstock. Water electrolysis performs the reaction shown in Eq. 2.

$${H}_{2} O \to 2 {H}_{2} + {O}_{2} \qquad Equation 2$$

Water electrolysis is a well-developed and rapidly growing commercial technology; proton exchange membrane (PEM) electrolyzers can operate at up to ˜80% energy efficiency at 2 A cm⁻². Alkaline water electrolysis is experiencing rapid scale-up and deployment, with numerous companies announcing plans for GW-scale electrolyzer manufacturing plants by 2030. Water electrolysis can be powered by renewable energy (wind or solar energy) or another low-carbon electricity source such as nuclear power.

Liquid fuels currently provide 30% of global energy demand and are likely to remain a major pillar of global energy supply for many decades. Achieving a carbon-neutral energy system will therefore likely require replacing fossil-derived liquid fuels with renewable alternatives made from CO₂, H₂O, and low-carbon energy. At present, the only significant source of renewable liquid fuels are biofuels produced from agricultural products (e.g., corn, sugarcane, palm oil). Biofuel production is limited by the low efficiency of natural photosynthesis, which has a global average of ˜0.2%. As they are currently produced, biofuels also compete with food for arable land, which can lead to environmentally devastating land use changes. The conversion of renewable electric power to liquid fuel is an attractive alternative because it could take advantage of the relatively high efficiency and falling costs of low-carbon electricity and it would not require arable land.

Previously reported RWGS catalysts include transition metal nanoparticles on catalyst supports, metal oxides, metal carbides, and metal sulfides. Most of these catalysts have been developed for high-temperature RWGS (>600° C.) and only a small subset have substantial activity at lower temperatures (≤600° C.). While operating at high temperatures allows for high single-pass conversion, it necessitates the use of more expensive reactors, heaters, and insulating materials. It also makes it more difficult to use electric heating, which is essential for powering the system with renewable or low-carbon electricity. Performing RWGS at ≤600° C. is advantageous if it is combined with a subsequent step that can utilize gas mixtures containing CO₂ and CO with a relatively high CO₂ content. Alternatively, the gaseous products of a RWGS reactor can be separated and recycle loops can be used to achieve high CO₂ conversion to CO over multiple passes.

A major limitation of previously reported RWGS catalysts is that many produce methane as a side product by catalyzing the exothermic methanation reaction (Eq. 3).

$${CO}_{2} + 4 {H}_{2} \to {CH}_{4} + 2 {H}_{2} O ( {ΔH°}_{298 K} = - 25 2.9 kj {mol}^{- 1} ) \qquad Equation 3$$

Because methane formation requires 4 H₂ instead of 1 for RWGS, methane formation tends to increase as the CO₂:H₂ gas ratio supplied to the reactor is decreased.

As an illustrative example, a catalyst consisting of Pt nanoparticles dispersed on TiO₂ (Pt/TiO₂) has been reported to achieve near-equilibrium RWGS conversion with a 1:1 CO₂:H₂ input ratio at a weight hourly space velocity (WHSV) of 12 h⁻¹ from 300° C.-600° C.(Kim, Lee & Hong, Appl. Catal. B, 119, 100-108 (2012)). However, as will be further discussed below, Pt/TiO₂ produces significant amounts of CH₄ with a 1:3 CO₂:H₂ feed.

Methane formation is undesired for any application of RWGS as part of a process to produce liquid fuels or multi-carbon chemicals because methane formation reduces the yield of the desired fuels or multi-carbon chemicals. Methane is also a highly potent greenhouse gas (GHG), at least 25× more potent than CO₂. If it is released to the atmosphere as a side product in a CO₂ conversion process, it can negate the GHG benefits of utilizing CO₂.

Previously reported RWGS catalysts are susceptible to a number of deactivation pathways that reduce catalyst lifetime, which increases both the material and operating costs of a process. Common deactivation mechanisms include the formation of carbonaceous deposits on the catalyst surface (“coking”), sintering of the catalytically active component (e.g., a transition metal nanoparticle) to reduce its surface area, or reduction of the oxidation state of the catalyst that results in lower RWGS activity or a change in selectivity to favor an undesired product like methane.

Sources of CO₂ often contain impurities, including sulfur-containing gases such as H₂S, thiols, thioethers, and SO₂, and nitrogen-containing gases such as ammonia, amines, and HCN. Most previously reported RWGS catalysts are poisoned by one or more of these impurities such that the impurity binds to the catalyst and reduces RWGS activity or alters selectivity. Removing impurities that poison catalysts from CO₂ sources requires additional process equipment, energy, and cost, which decreases the overall efficiency of a CO₂ to fuels or chemicals process. Catalysts that involve transition metals or transition metal oxides are likely to be poisoned by sulfur-containing impurities (Rodriguez & Hrbek, Acc. Chem. Res. 32, 719-728 (1999)).

This invention describes RWGS catalysts comprising alkali carbonates (M₂CO₃; M=Li, Na, K, Rb, Cs) dispersed in mesoporous materials. Mesoporous materials are materials with pores with diameters between 2 nm and 50 nm. Examples include mesoporous oxides such as mesoporous alumina (Al₂O₃), silica (SiO₂), and various mesoporous oxides of zirconium, cerium, tin, niobium, and tantalum. Other examples include mesoporous carbon materials such as activated carbon.

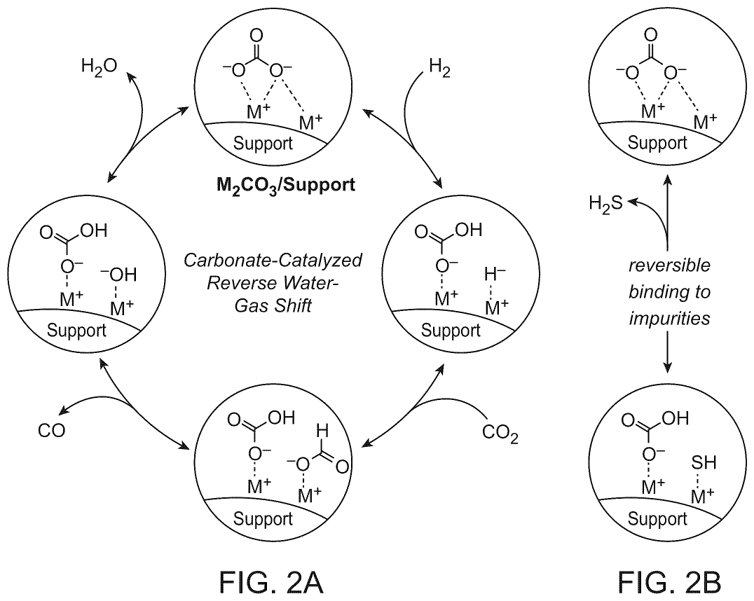

Dispersion of M₂CO₃ in a mesoporous material results in a high surface area of M₂CO₃ and renders a substantial portion of the M₂CO₃ amorphous, or non-crystalline. These dispersed carbonate materials are able to deprotonate very weakly acidic molecules at elevated temperature in the presence of CO₂. For example, Cs₂CO₃ or K₂CO₃ dispersed in mesoporous TiO₂ or mesoporous carbon can deprotonate a benzene C—H bond in the presence of 10 bar CO₂ at ˜400° C., generating a putative carbanion intermediate that reacts with CO₂ to form benzoate (Xiao, Chant, Frankhouser, Chen, Yau, Washton & Kanan, Nat. Chem., 11, 940-947 (2019)). Benzene has a gas phase acidity of 400 kcal/mol, which is the enthalpy change for the dissociation of benzene into a proton and C₆H₅ anion in the gas phase. Since H₂ has the same gas phase acidity as benzene, we hypothesized that dispersed carbonates would catalyze RWGS in a similar temperature regime via a cycle involving H₂ carboxylation to form formate (HCO₂) and subsequent dehydroxylation to form CO, as shown in FIG. 2A.

Because alkali cations have very weak affinity for CO, dispersed carbonates should be incapable of reducing CO further to CH₄ during RWGS. While M₂CO₃ is likely to react with H₂S through acid-base chemistry, this process should be completely reversible under RWGS conditions because alkali sulfides are not stable in the presence of H₂O, as shown in FIG. 2B. Thus, we further hypothesized that dispersed carbonates would be highly selective and sulfur tolerant.

In some embodiments, RWGS using the catalysts disclosed in this invention can be combined with anaerobic gas fermentation to generate liquid fuels or chemicals from CO₂ and H₂. Anaerobic gas fermentation is a process in which acetogenic microorganisms convert a C₁ feedstock (CO and/or CO₂) and an energy source (CO and/or H₂) into chemicals and fuels. Gas fermentation has been developed in industry over the past 20 years and recently commercialized as a technology to produce ethanol fuel from waste gas streams that are rich in CO, such as industrial off-gases or pyrolyzed biomass. Ethanol can be blended with gasoline for light vehicles or upgraded to jet fuel using established technologies.

Instead of using emission streams that are rich in CO, which are limited and can be difficult to access, the feedstock gas for anaerobic gas fermentation can be prepared from CO₂, H₂O, and renewable power in a power-to-fuel process. The feedstock gas needs to contain CO and may contain H₂ and CO₂. While the opportunity to utilize gas fermentation in a power-to-fuel process has been recognized, the only technology that has received substantial attention for preparing the requisite CO component is low-temperature CO₂ electrolysis. Although significant progress has been made over the past decade, low-temperature CO₂ electrolysis is still in an early stage of development and faces a number of major science and engineering challenges for use in fuel production. The energy efficiency of low-temperature CO₂ electrolyzers that produce CO has been limited to 40-45% at modest current densities (˜0.2 A cm⁻²) because of problems caused by carbonate formation in the cell (Rabinowitz and Kanan, Nat. Commun., 11, 5231 (2020)). Low-temperature CO₂ electrolyzers utilize specialized components that have never been produced at a large scale (CO₂ reduction gas diffusion electrodes and anion exchange membranes) and precious metal anodic catalysts (e.g., IrO₂) to minimize overpotential losses and avoid corrosion. Achieving efficient mass transport is uniquely challenging for a CO₂ electrolyzer because it requires delivering a gaseous reactant and removing both gaseous (CO, unreacted CO₂) and liquid (H₂O) products. The coinage metals (typically Ag) that are used as the cathodic catalyst for selective CO₂ reduction to CO are irreversibly poisoned by low levels of H₂S. An alternative strategy is to use H₂O electrolysis to produce H₂ and then convert CO₂ and H₂ into a CO/CO₂/H₂ feedstock by performing RWGS (as shown in Eq. 1) in a fixed-bed reactor. The reactor design principles for heterogeneously catalyzed transformations of gaseous reactants are well established from the refining and chemicals industry such that with a suitable catalyst, RWGS could be rapidly scaled for use in power-to-fuel systems.

The selectivity and productivity of anaerobic gas fermentation depend on the composition of the feedstock gas supplied to the fermenter, and in particular on the CO:CO:H₂ ratio. The stoichiometry for CO₂ hydrogenation to any saturated acyclic alcohol corresponds to a 1:3 CO₂:H₂ ratio, whereas CO hydrogenation to alcohol requires a 1:2 CO:H₂ ratio. With CO₂, H₂O, and energy as the primary inputs, a 1:3 CO₂:H₂ feedstock is the easiest to prepare because it requires only water electrolysis. Unfortunately, a 1:3 CO₂:H₂ feedstock (with no CO) is not suitable for commercial alcohol production because most acetogens produce only acetate from this mixture and those that do produce alcohol have low growth rates, low productivity, and modest selectivity. A 1:2 CO:H₂ feedstock supports high microbial growth and alcohol productivity, but this mixture is the most difficult to prepare from CO₂ and H₂O. In between 1:3 CO₂:H₂ and 1:2 CO:H₂ are any number of CO:CO₂:H₂ ratios with the appropriate stoichiometry for alcohol synthesis. Recent developments indicate that relatively low CO:CO₂ ratios are sufficient for high gas fermentation alcohol productivity. Commercially viable gas fermentation has been demonstrated using gasified agricultural residues as the feedstock, which typically has a CO:CO₂ ratio of ˜1:1. Thus, gas fermentation can utilize relatively CO₂-rich gas streams.

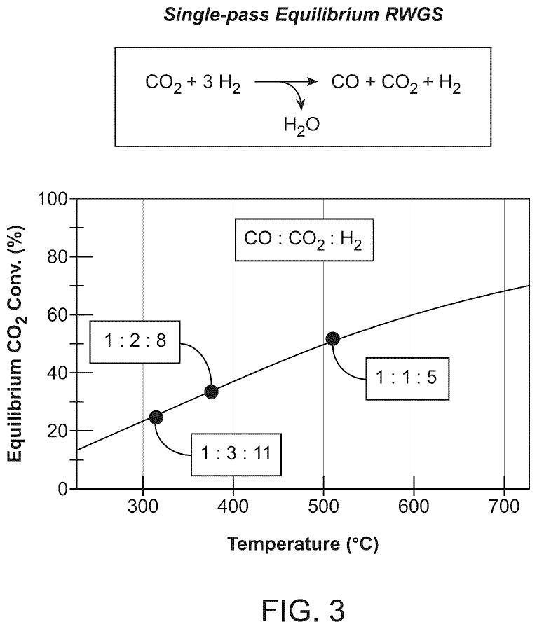

The use of RWGS to prepare CO/CO₂/H₂ gas fermentation feedstocks from CO₂ and H₂ requires a catalyst that meets a number of criteria. To minimize the process complexity and energy demand, the catalyst should operate at the equilibrium-limited single-pass conversion with an industrially relevant space velocity at the temperature needed to produce a suitable gas ratio to sustain robust gas fermentation of the desired fuel or chemical product. FIG. 3 is a graph showing equilibrium-limited CO₂ conversion percentage to CO versus temperature in degrees centigrade and various output CO:CO₂:H₂ gas ratios obtained after H₂O removal for a RWGS reactor operating with an input of 1:3 CO₂:H₂. For example, with an input of 1:3 CO₂:H₂, the equilibrium-limited RWGS conversion corresponds to an output CO:CO₂:H₂ gas ratio of 1:1:5 at 504° C. Given the apparent commercial viability of this ratio for ethanol production, some embodiments take 504° C. to be the maximum target temperature. Further developments in gas fermentation processes may make lower ratios and correspondingly lower temperatures viable, e.g., 1:2:8 CO:CO₂:H₂ at 375° C.

The RWGS catalyst must also avoid the exothermic reaction to produce CH₄, as shown in Equation 3. Any CH₄ produced by the catalyst would need to be vented or combusted to prevent its accumulation because acetogens cannot metabolize CH₄. Venting even a small percentage of CH₄ negates the GHG benefit of utilizing CO₂ because of the 25× higher global warming potential of CH₄ compared to CO₂.

The RWGS will preferably need to operate in the presence of H₂S impurities because H₂S is a significant impurity in some of the most accessible emissions sources for CO₂ utilization, including off-gases from ammonia production and corn ethanol fermentation, and H₂S is also produced in the gas fermentation process itself.

Some embodiments provide dispersed carbonate RWGS catalysts to convert H₂ and CO₂ to an appropriate ratio of CO/CO₂/H₂ for anaerobic gas fermentation. In some embodiments, dispersed carbonates can produce the necessary output gas via equilibrium-limited RWGS at ≥430° C. at useful space velocities for at least days of operation with no apparent degradation and no H₂S sensitivity. Additionally, such catalysts are trivial to synthesize and can be readily scaled for rapid deployment. These results provide a compelling case for utilizing carbonate-catalyzed RWGS to bridge the gap between H₂ and gas fermentation to ethanol, other multi-carbon alcohols, or other valuable multi-carbon products as fermentation technology develops. By upgrading the alcohol products to jet fuel, this strategy could be used to produce sustainable aviation fuel without harvesting biomass.

In other embodiments, RWGS using the catalysts disclosed in this invention can be combined with subsequent chemical or other abiotic process steps to generate liquid fuels or chemicals. In some embodiments, Fischer-Tropsch catalysis is used to convert the RWGS product gas into hydrocarbons for hydrocarbon fuels such as gasoline, diesel, or aviation fuels. More broadly, the RWGS product gas can be converted to other products using any process that converts syngas to liquid fuels or other multi-carbon chemical products. The RWGS product gas may be subjected to one or more separation steps to separate or enrich components of the product gas prior to other catalytic steps that convert the product gas or components thereof into liquid fuels or other multi-carbon chemical products.

### Embodiments Using Cs.CO₃

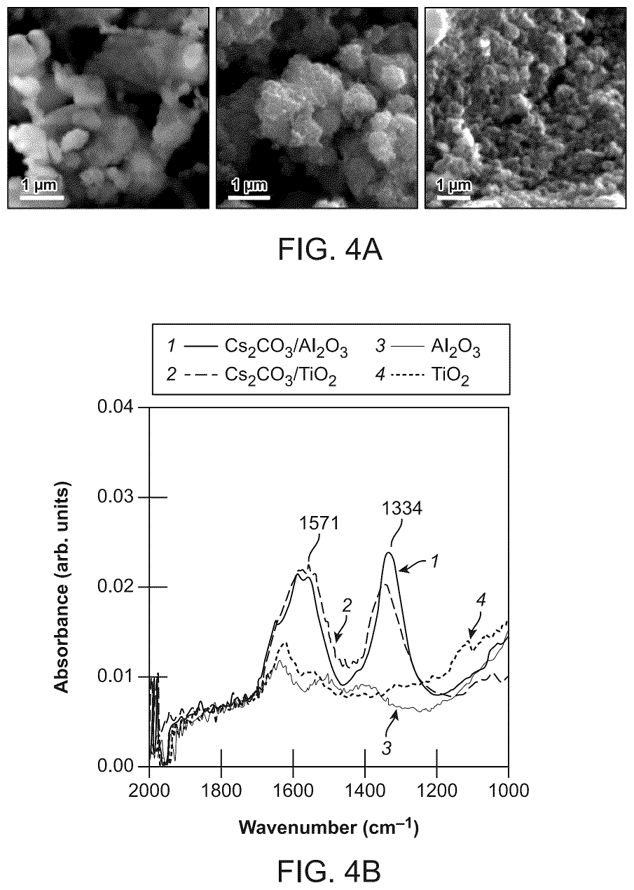

In some embodiments, materials with a high degree of carbonate dispersion that are suitable for fixed bed reactors can be easily prepared from commercially available mesoporous TiO₂, Y—Al₂O₃, and granular activated carbon (GAC) supports using incipient wetness impregnation. For the examples described here, TiO₂ pellets, γ-Al₂O₃ pellets, and granular activated carbon catalyst supports were all purchased from Alfa Aesar of Tewksbury, MA. As-purchased γ-Al₂O₃ or TiO₂ pellets were ground lightly in a mortar and pestle and sieved to a size fraction of 250-500 μm (35-60 mesh). The GAC support was etched with 2 M KOH and washed with aqueous HCl prior to loading. The surface areas of the support materials before Cs₂CO₃ loading determined by Brunauer-Emmett-Teller (BET) N₂ sorption were 153 m²/g, 251 m²/g, and 608 m²/g, respectively. Cs₂CO₃ was loaded into the supports via incipient wetness impregnation using an aqueous solution for γ-Al₂O₃ and TiO₂ and a methanolic solution for GAC. The final Cs₂CO₃ loading was 34.3 wt % for Cs₂CO₃/γ-Al₂O₃, 23.2 wt % for Cs₂CO₃/TiO₂, and 10.4 wt % for Cs₂CO₃/GAC. SEMs of the dispersed carbonate catalysts on a porous substrate are shown in FIG. 4A.

Infrared (IR) spectroscopy was performed to qualitatively assess the degree of carbonate surface dispersion and the nature of the CO₃² coordination environments. FIG. 4B is a graph of absorbance versus wave number. These measurements were performed after long RWGS runs to allow for any rearrangements that occur during operation. For both materials, the C—O stretching region is dominated by a pair of broad peaks centered at ˜1570 and ˜ 1340 cm⁻¹, which is indicative of reduced symmetry in the CO₃² coordination environment compared to the bulk crystalline lattice. The magnitude of the peak splitting is consistent with a bidentate and/or bridging coordination to the Cs⁺ cation, as has been assigned previously based on IR spectra of K₂CO₃ dispersed in γ-Al₂O₃. These results indicate that a dispersed, non-crystalline carbonate is stable on the Cs₂CO₃/TiO₂ and Cs₂CO₃/Al₂O₃ materials under RWGS conditions. Excessive scattering by the GAC support material prevented IR characterization of Cs₂CO₃/GAC.

CO₂ hydrogenation reactions were carried out in a ⅜″ O.D. (0.305″ I.D.) 316 stainless steel fixed bed reactor equipped with a vertical furnace. For each reaction, an amount of catalyst containing 500 mg of support material was loaded into the reactor and heated while exposing to a flowing mixture of H₂ and CO₂ gas (10 bar pressure, 3:1 H₂:CO₂) at a rate of 40 standard cubic centimeters per min (sccm), which corresponds to a weight hourly space velocity (WHSV, mass of gas per mass of catalyst per hour) of 2.0 h⁻¹ for Cs₂CO₃/Al₂O₃ and 2.1 h⁻¹ for Cs₂CO₃/TiO₂. This WHSV was chosen to be within the range of values that are used in industrial applications of heterogeneously catalyzed gas-phase reactions while enabling convenient evaluation of multiple materials over long-duration experiments. Water produced in the reaction was collected in a gravity trap, while the gaseous products were passed to a gas chromatograph (GC) for analysis at regular intervals. CO, CO₂, and CH₄ were quantified in each GC analysis based on independent calibration standards. Some embodiments provide a weight hourly space velocity (WHSV) of ≥2 h⁻¹.

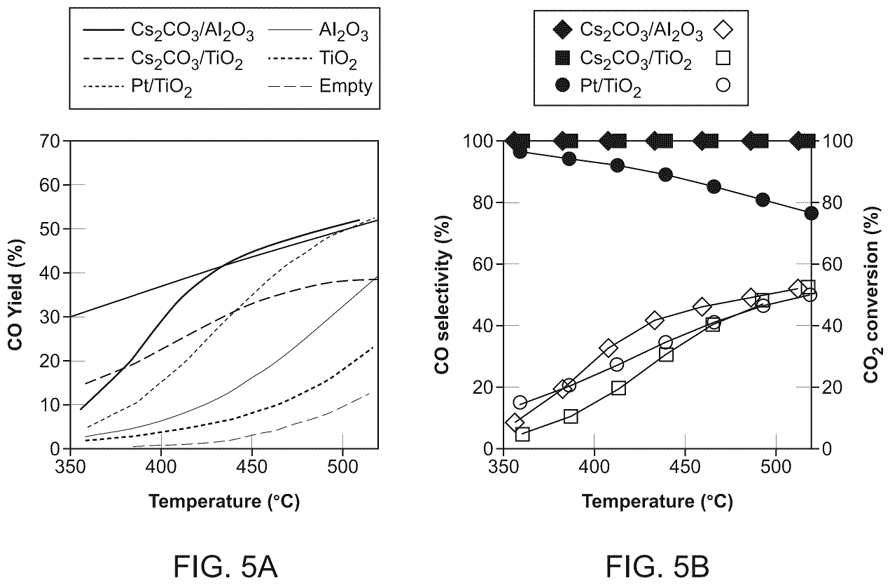

An initial survey was performed by stepping the reactor temperature from 355 to 520° C. in 25-30° C. increments, with each temperature step held for 4 h. These experiments revealed that the dispersed carbonates are highly active and selective RWGS catalysts at temperatures greater than ˜400° C. FIG. 5A compares the steady-state CO yield at each temperature step for dispersed carbonates, unloaded oxide supports, and a commercial Pt catalyst. A control experiment with the empty reactor showed a small amount of CO production across the temperature screen, which reflects low levels of RWGS activity catalyzed by the stainless steel reactor walls. The unloaded TiO₂ support showed moderate CO production above this background level but was still far below the equilibrium-limited conversion even at the highest temperature evaluated. By contrast, the Cs₂CO₃/TiO₂ attained the RWGS equilibrium-limited CO yield at >490° C.(denoted by the black dashed line). Notably, TiO₂ is partially reduced under the H₂-rich atmosphere used in these experiments. A reducible support is not beneficial for carbonate-catalyzed RWGS, however, as seen by the results using an irreducible Al₂O₃ support. The unloaded γ-Al₂O₃ support itself showed considerably higher CO production than unloaded TiO₂, but did not reach the equilibrium-limited yield even at 515° C. The Cs₂CO₃/Al₂O₃ catalyst was substantially more active than Cs₂CO₃/TiO₂, reaching the equilibrium-limited CO yield at ≥430° C. Both Cs₂CO₃/TiO₂ and Cs₂CO₃/Al₂O₃ showed essentially 100% selectivity for CO.

An oxide support is not essential for carbonate-catalyzed RWGS. Whereas a GAC support showed no increase in CO production relative to the empty reactor, the Cs₂CO₃/GAC catalyst came close to the equilibrium-limited CO yield (within a few percentage points) at ≥450° C. Cs₂CO₃/GAC was less active than Cs₂CO₃/TiO₂ or Cs₂CO₃/Al₂O₃, but the Cs₂CO₃ loading was substantially lower in Cs₂CO₃/GAC (10 wt % vs 23-34 wt %) because of the need to use a methanolic Cs₂CO₃ solution with this more hydrophobic support. Increasing the loading would likely improve the performance with this material.

For performance comparison with transition metal-catalyzed RWGS, a commercial platinum nanoparticle catalyst (1 wt. % Pt/TiO₂) was examined (500 mg catalyst, corresponding to a WHSV of 2.7 h⁻¹). To our knowledge, Pt/TiO₂ is the most active previously reported RWGS catalyst (on a mol CO per g catalyst per s basis) in the 300-500° C. range. As seen in FIG. 5A, the commercial Pt/TiO₂ catalyst showed considerable RWGS catalysis at all temperatures examined. In contrast to Cs₂CO₃/TiO₂ and Cs₂CO₃/Al₂O₃, however, Pt/TiO₂ never reaches the equilibrium-limited CO yield because of competitive CH₄ formation. FIG. 5B compares the CO₂ conversion and selectivity for CO vs temperature for PU/TiO₂, Cs₂CO₃/TiO₂, and Cs₂CO₃/Al₂O₃. Whereas the dispersed Cs₂CO₃ catalysts are essentially 100% selectivity for CO across all temperatures, Pt/TiO₂ shows increasing CH₄ production as the temperature is increased, reaching ˜12% (24% of C) products) at 520° C. The exothermic methanation of CO₂/CO (Eq. 3) is a common competing reaction pathway for RWGS catalysts. The absence of CH₄ with dispersed carbonate catalysts is consistent with the notion that the low CO affinity of Cs⁺ precludes further reduction

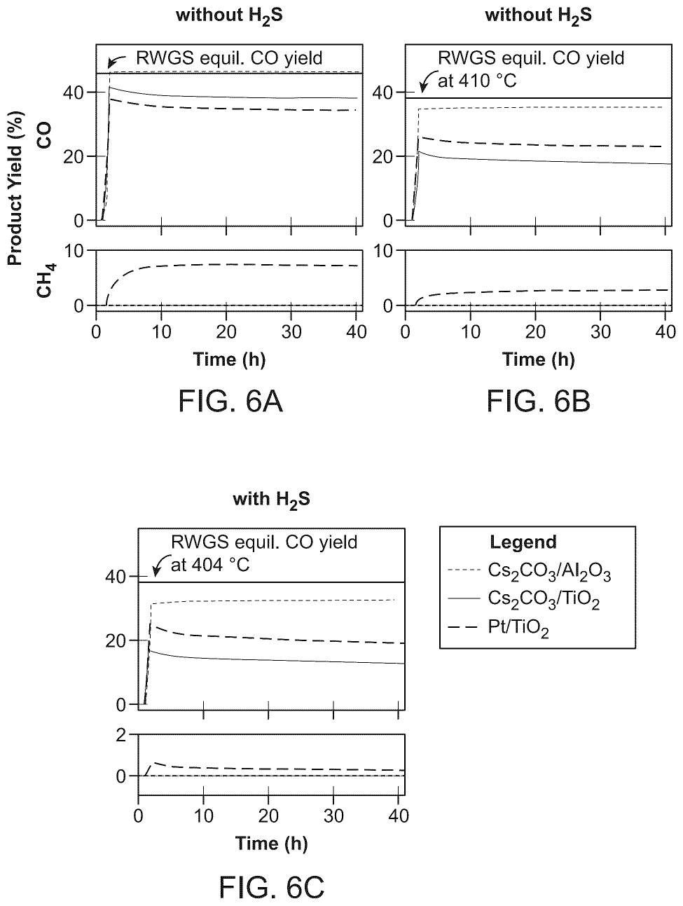

To assess their stability, Cs₂CO₃/Al₂O₃ and Pt/TiO₂ were compared in 40 h reactions performed under the same flowing conditions (3:1 H₂:CO₂, 10 bar, 40 sccm) at 468° C. FIG. 6A is a graph of CO and CH₄ yield versus time for these experiments. Cs₂CO₃/Al₂O₃ maintained the equilibrium-limited CO yield without producing CH₄ for the entire run, with no detectable degradation in performance. In order to demonstrate stability, in contrast, with Pt/TiO₂ the CH₄ remained above 6% after reaching the temperature setpoint but oscillated between 7.5% and 6.6% over the course of the run. The high CH₄ yield was coupled with a slow reduction in CO yield from 37.9% to 34.4%. This result suggests that there are rearrangements of the Pt nanoparticles on the multi-hour timescale that change the distribution of active sites, which is a common phenomenon for transition metal nanoparticle-based catalysts.

The stability of the catalysts at sub-equilibrium conversion temperatures were also assessed in 40+hr reactions performed at 410° C. and the same flow conditions (3:1 H₂:CO_{2, 10} bar, 40 sccm, as shown in FIG. 6B). For the Cs₂CO₃/Al₂O₃, the CO yield remained steady at 35.2% with negligible CH₄ production. Cs₂CO₃/TiO₂ exhibited similar selectivity for CO but had a much lower CO yield over the course of the experiment, falling to 16.9%. The Pt/TiO₂ also saw a loss in CO yield over the course of the experiment, but CH₄ production slowly increased from 1.9% to 2.8%.

Finally, the effect of sulfur-containing impurities was assessed by performing a 40+h stability test at 404° C. with a gas mixture in which 50 ppm of H₂S gas was introduced into the 1:3 CO₂:H₂ feed, as shown in FIG. 6C. For Pt/TiO₂, the presence of H₂S primarily attenuated CH₄ formation such that 0.3% CH₄ yield was maintained throughout the run. In addition, the CO yield showed a slow decline from 22.5% to 19.8% over the course of 40 h. Since the CH₄ production is essentially constant, we attribute this decline to a slow poisoning of the RWGS sites on the Pt particles, which is consistent with other studies of H₂S effects on Pt catalysts. In contrast, the Cs₂CO₃/Al₂O₃ showed essentially the same CO yield and 100% CO selectivity over 40 h.

The demonstration of robust carbonate-catalyzed RWGS activity under application-relevant conditions motivates a preliminary assessment of the accessible energy conversion efficiency for a power-to-ethanol system that utilizes this technology of electrolysis and RWGS. An estimate can be made by examining the energy requirements for each of the primary process steps: 1) electrolytic H₂ production, 2) RWGS, 3) fermentation, and 4) isolation of the product via distillation. Based on our results above, we assume a 1:1:5 CO:CO₂:H₂ gas ratio output from the RWGS unit operating at the equilibrium-limited CO₂ conversion at ˜500° C. Commercial PEM electrolyzers operate at 80% efficiency, requiring 364 KJ mol⁻¹ H₂ generated. The RWGS unit must supply the reaction enthalpy of 37.1 kJ mol⁻¹ CO produced at 500° C. At the required process temperature, industrial electric heaters can approach 100% efficiency. Based on the reported emissions intensity of acetogenic fermentation of syngas to ethanol, estimates for utilities requirements and energy recovery place the total energy requirement for fermentation and distillation at 0.39 MJ mol⁻¹ ethanol. Accounting for the carbon efficiency of fermentation (91%) and adjusting for the stoichiometry of ethanol production (i.e., 6 mol H₂ required per 1 mol CO produced via RWGS), the total baseline power requirement for the system is estimated at 2.82 MJ mol⁻¹ ethanol, corresponding to a 48.5% efficiency for power to fuel grade ethanol.

In contrast to CO₂ electrolysis, the reactor design principles for large-scale, heterogeneously catalyzed gas-phase processes are very well-established from many decades of their use in the chemical and fuel industries. The dispersed carbonate RWGS catalysts described here are trivial to prepare from readily available, non-precious materials (e.g., Cs₂CO₃ and γ-Al₂O₃). The H₂S tolerance of carbonate-catalyzed RWGS could obviate the need for desulfurization, reducing the overall process complexity and energy demand.

### Embodiments Using K₂CO₃ or Na₂CO₃

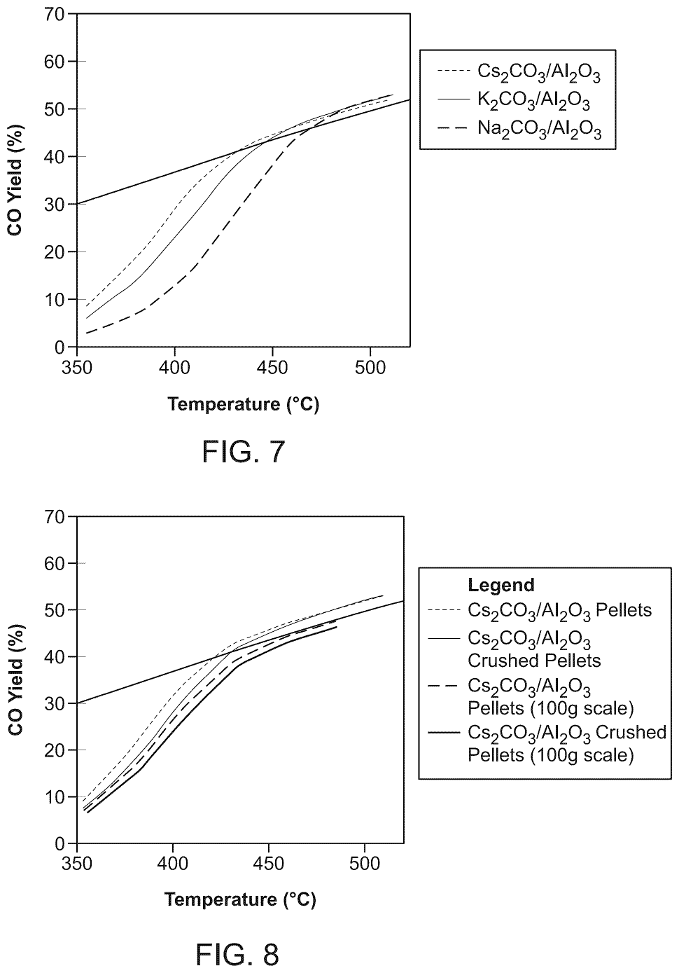

To assess the performance of other alkali carbonates, K₂CO₃/Al₂O₃(18.1 wt % K₂CO₃) and Na₂CO₃/Al₂O₃(14.5 wt %) were prepared in the same way as Cs₂CO₃/Al₂O₃ using the same γ-Al₂O₃ powder such that molar alkali metal carbonate loading was consistent. An amount of catalyst containing 500 mg of support was loaded into the reactor and heated while exposing to a flowing mixture of H₂ and CO₂ gas (10 bar pressure, 3:1 H₂:CO₂) at a rate of 40 sccm. The RWGS performance was surveyed by stepping the reactor temperature from 355 to 520° C. in 25° C. increments, with each step held for 3 h. The results are shown in FIG. 7. All catalysts were able to reach equilibrium conversion during the course of the reaction while remaining essentially 100% selective for CO. Cs₂CO₃/Al₂O₃ reached equilibrium conversion at the lowest temperature of ˜430° C., followed by K₂CO₃/Al₂O₃ at ˜450° C., and finally Na₂CO₃/Al₂O₃ at ˜480° C.

### Embodiments Using Non-Powder Catalyst Morphologies

Various embodiments using dispersed carbonate RWGS catalysts will require using larger reactor tubes, such as tubes with I.D. greater than or equal to 2″. These larger tubes generally require using catalysts with mm or larger particle dimensions, such as pellets or spheres. To assess performance in a larger morphology, Cs₂CO₃ was loaded directly into the cylindrical γ-Al₂O₃ pellets (4 mm length; 3 mm diameter) via incipient wetness (34.3 wt % Cs₂CO₃). Two separate batches were prepared, one from a small 1.5 g sample of pellets and another from 100 g of pellets. The resulting Cs₂CO₃/Al₂O₃(pellet) catalysts were evaluated in RWGS reactions. An amount of catalyst containing 500 mg of support was loaded into the reactor and heated while exposing to a flowing mixture of H₂ and CO₂ gas (10 bar pressure, 3:1 H₂:CO₂) at a rate of 40 sccm. The RWGS performance was surveyed by stepping the reactor temperature from 356 to 487° C. in 25° C. increments, with each step held for 3 h. The results are shown in FIG. 8. The performance of Cs₂CO₃/Al₂O₃(pellet) catalysts was very similar to Cs₂CO₃/Al₂O₃ catalysts with powder morphology, with the equilibrium-limited CO yield reached at ≥430° C. and essentially no CH₄ detected.

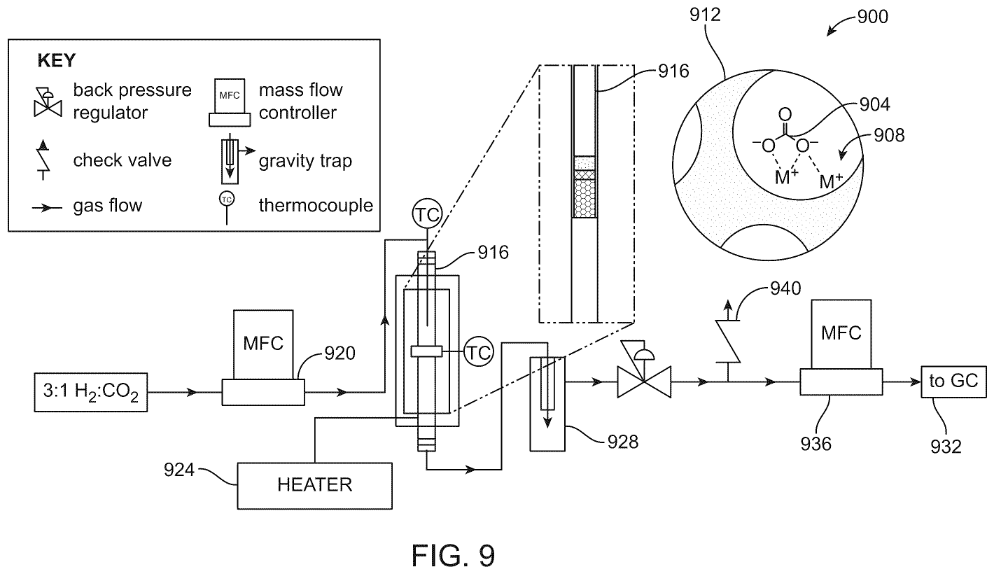

FIG. 9 is a schematic view of a system 900 for providing RWGS used in some embodiments. The dispersed alkali metal carbonate 904 is in pores 908 of a porous support 912 placed inside a fixed bed reactor 916. H₂ and CO₂ gas are supplied to the catalyst by MFC(s) 920. The entire system is pressurized with pressure being maintained by a back pressure regulator downstream of the reactor. The reactor is heated by a proportional-integral-derivative (PID) heater 924. Internal and external K-type thermocouples are used to measure the temperature. The product water is captured in a gravity trap 928 downstream of the reactor. The gaseous products continue to flow to a gas chromatography machine (GC) 932 for quantification. The downstream MFCs 936 maintain a regular flow rate and allow for dilution which are practical considerations for calculating yields but do not affect performance. A check valve 940 is also included as a safety measure, but also does not affect performance.

### Alternative Embodiments

Other embodiments may use other inorganic bases as well as other cations to achieve robust and selective RWGS catalysis provided the materials are adequately dispersed in a support that is compatible with these conditions. Tailoring the support pore volume and surface area to enable maximal loading of dispersed bases is a straightforward strategy to maximizing RWGS activity. The ability to utilize different support materials also provides flexibility to tailor other catalyst properties relevant to industrial application such as thermal conductivity. In various embodiments, the alkali carbonate is in the form of M₂CO₃, where M⁺=lithium (Li⁺), sodium (Na⁺), potassium (K⁺), rubidium (Rb⁺), and/or cesium (Cs⁺). In some embodiments, the catalyst is substantially free of elements in groups 5 through 12 of the periodic table, wherein group 5 is the column of the periodic table beginning with vanadium (V) and group 12 is the column of the periodic table beginning with zinc (Zn). The lack of these elements in groups 5 through 12 renders the catalyst more tolerant to impurities found in CO₂ gas sources. In some embodiments, alkali carbonate is substantially amorphous. The lack of crystallinity increases the surface area and engenders greater reactivity for the M₂CO₃. The substrate is a porous substrate. In some embodiments, the substrate is mesoporous with an average pore size in the range of 2 nm to 50 nm. In some embodiments, the substrate has an open porosity in the range of 5% to 50% determined by Barret-Joyner-Halenda (BJH) analysis of N₂ gas sorption isotherms. In some embodiments, the substrate has an open porosity in the range of 15% to 40%/In some embodiments, the substrate is an oxide material. In some embodiments, the substrate is a metal or metalloid oxide. In some embodiments, the substrate is one or more of substrates commonly used as catalyst carriers in chemical processes, such as titania (TiO₂), alumina (Al₂O₃), zirconia (ZrO₂), or a carbon material, such as granular activated carbon. In some embodiments, the catalyst is heated to a temperature above 350° C. during the RWGS process. In some embodiments, the catalyst is heated to a temperature above 400° C. during the RWGS process. In some embodiments, the catalyst is heated to a temperature in the range of 300° C. to 600° C. in order to enable the use of ordinary materials of construction for the reactor. In some embodiments, the output of the RWGS process is CO and H₂O and is free of CH₄. In some embodiments, the output of the RWG process is CO and H₂O and less than 2% CH₄. In other embodiments, the output of the RWG process is CO and H₂O and less than 1% CH₄. In other embodiments, the output of the RWG process is CO and H₂O and less than 0.5% CH₄. In other embodiments, the output of the RWG process is CO and H₂O and less than 0.1% CH₄.

While this invention has been described in terms of several preferred embodiments, there are alterations, permutations, modifications, and various substitute equivalents, which fall within the scope of this invention. It should also be noted that there are many alternative ways of implementing the methods and apparatuses of the present invention. It is therefore intended that the following appended claims be interpreted as including all such alterations, permutations, modifications, and various substitute equivalents as fall within the true spirit and scope of the present invention. As used herein, the phrase “A, B, or C” should be construed to mean a logical (“A OR B OR C”), using a non-exclusive logical “OR,” and should not be construed to mean only one of A or B or C. Each step within a process may be an optional step and is not required. Different embodiments may have one or more steps removed or may provide steps in a different order. In addition, various embodiments may provide different steps simultaneously instead of sequentially.

What is claimed is:

1. A catalyst for performing a reverse-water-gas-shift (RWGS) reaction comprising:
a porous support; and
an alkali carbonate dispersed on the porous support.

2. The catalyst, as recited in claim 1, wherein the alkali carbonate is in a form of M₂CO₃,
where M⁺=Lit, Na⁺, K⁺, Rb⁺, and/or Cs⁺.

3. The catalyst, as recited in claim 1, wherein the catalyst is substantially free of elements in groups 5 through 12 of the periodic table, wherein group 5 is a column of the periodic table beginning with V and group 12 is a column of the periodic table beginning with Zn.

4. The catalyst, as recited in claim 1, wherein the porous support comprises at least one of titania (TiO₂), alumina (Al₂O₃), zirconia (ZrO₂), or a carbon material.

5. The catalyst, as recited in claim 1, wherein the catalyst is not poisoned by sulfur-containing impurities.

6. The catalyst, as recited in claim 1, wherein the alkali carbonate is substantially amorphous.

7. A method, comprising:
i) providing an alkali carbonate catalyst on a porous support,
ii) supplying the catalyst with a flow of CO₂ and H₂ gas; and
iii) heating the catalyst to ≥350° C., resulting in an output containing CO.

8. The method, as recited in claim 7, wherein the alkali carbonate is in the form of M₂CO₃, where M⁺=Lit, Na⁺, K⁺, Rb⁺, and/or Cs⁺.

9. The method, as recited in claim 7, wherein the catalyst is substantially free of elements in groups 5 through 12 of the periodic table, wherein group 5 is a column of the periodic table beginning with V and group 12 is the column of the periodic table beginning with Zn.

10. The method, as recited in claim 7, wherein the porous support comprises at least one of titania (TiO₂), alumina (Al₂O₃), zirconia (ZrO₂), or a carbon material.

11. The method, as recited in claim 7, wherein the alkali carbonate is substantially amorphous.

12. The method, as recited in claim 7, wherein the supplying the catalyst with a flow of CO₂ and H₂ gas further supplies H₂S impurities.

13. The method, as recited in claim 7, further comprising providing a weight hourly space velocity (WHSV) of ≥2 h⁻¹.

14. The method, as recited in claim 7, further comprising synthesizing alcohol from the output containing CO.

15. The method, as recited in claim 14, wherein the synthesizing alcohol uses gas fermentation.

16. The method, as recited in claim 7, further comprising synthesizing hydrocarbons from the output containing CO.

17. The method, as recited in claim 16, wherein synthesizing hydrocarbons uses Fischer-Tropsch catalysis.

18. The method, as recited in claim 7, further comprising providing electrolysis to provide H₂.

19. The method, as recited in claim 7, further comprising one or more separation steps performed on an output gas.
